(19) United States
(12) Patent Application Publication
(10) Pub. No.: US 2025/0097322 A1
(43) Pub. Date: Mar. 20, 2025

(54) MOBILITY SERVICE SYSTEM AND METHOD FOR REDUCING AMOUNT OF DATA

(71) Applicant: DENSO CORPORATION, Kariya-city (JP)

(72) Inventor: Masatoshi KOMIYAMA, Kariya-city (JP)

(21) Appl. No.: 18/954,047

(22) Filed: Nov. 20, 2024

Related U.S. Application Data
(63) Continuation of application No. PCT/JP2023/020154, filed on May 30, 2023.

(30) Foreign Application Priority Data
May 31, 2022 (JP) 2022-089071

(51) Int. Cl. H04L 69/04; H04W 4/40

(52) U.S. Cl. CPC H04L 69/04; H04W 4/40

(57) ABSTRACT

Disclosed is a technique of reducing an amount of data of a content including a video or an audio, and the content is acquired by an acquisition device of a vehicle. In the technique, an in-vehicle device generates an in-vehicle partial content by reducing a data amount of the content using an in-vehicle reduction criterion corresponding to an application program executed by the in-vehicle device. The in-vehicle partial content is uploaded to a management server. The management server generates a server partial content by reducing a data amount of the in-vehicle partial content using a server reduction criterion corresponding to information related to the in-vehicle device. A terminal content is transmitted to a terminal device of an end user of a service based on the server partial content.

### CROSS REFERENCE TO RELATED APPLICATIONS

The present application is a continuation application of International Patent Application No. PCT/JP2023/020154 filed on May 30, 2023, which designated the U.S. and claims the benefit of priority from Japanese Patent Application No. 2022-089071 filed on May 31, 2022. The disclosures of all the above applications are incorporated herein.

### TECHNICAL FIELD

The present disclosure relates to a technology for reducing a data amount in a mobility service system.

### BACKGROUND

A vehicle is connected to a cloud server or the like on a network, and various data is uploaded and downloaded between the vehicle and the cloud.

### SUMMARY

According to an aspect of the present disclosure, a mobility service system includes an in-vehicle device and a management server. The in-vehicle device is mounted on a vehicle that includes an acquisition device configured to acquire a content including a video or an audio as an acquired content. The management server is configured to collect and store data from in-vehicle devices mounted on vehicles including the vehicle. The in-vehicle device includes an execution unit, an event detection unit, an in-vehicle reduction unit and an upload unit. The execution unit is configured to execute an application program corresponding to a service. The event detection unit is configured to detect an event related to the application program during execution of the application program by the execution unit. The in-vehicle reduction unit is configured to generate an in-vehicle partial content by reducing a data amount of the acquired content using an in-vehicle reduction criterion corresponding to the application program based on the event detection unit detecting the event. The upload unit is configured to upload the in-vehicle partial content generated by the in-vehicle reduction unit to the management server. The management server includes a server reduction unit and a terminal transmission unit. The server reduction unit is configured to generate a server partial content by reducing a data amount of the in-vehicle partial content uploaded by the upload unit using a server reduction criterion corresponding to information related to the in-vehicle device. The terminal transmission unit is configured to transmit a terminal content to a terminal device of an end user of the service based on the server partial content generated by the server reduction unit.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a schematic diagram illustrating a configuration of a mobility IoT system.

FIG. 2 is a block diagram illustrating a hardware configuration of an edge device.

FIG. 3 is a functional block diagram illustrating a functional configuration of an edge device.

FIG. 4 is a diagram illustrating a first layer of standardized vehicle data and

a data format.

FIG. 5 is a diagram illustrating a configuration of standardized vehicle data.

FIG. 6 is a flowchart illustrating content upload processing executed by an in-vehicle device.

FIG. 7 is a diagram schematically illustrating stepwise reduction of a data amount in the mobility IoT system.

FIG. 8 is a block diagram illustrating a hardware configuration of a management server.

FIG. 9 is a functional block diagram illustrating a functional configuration of the management server.

FIG. 10 is a functional block diagram illustrating functional configurations of a mobility GW and a data management unit.

FIG. 11 is a diagram illustrating a configuration of a shadow.

FIG. 12 is a diagram illustrating a configuration of a latest index.

FIG. 13 is a diagram illustrating a configuration of an index.

FIG. 14 is a flowchart illustrating content storage processing executed by the management server.

FIG. 15 is a block diagram illustrating a hardware configuration of a service server.

FIG. 16 is a block diagram illustrating a functional configuration of the service server.

FIG. 17 is a flowchart illustrating content acquisition processing executed by the service server.

FIG. 18 is a sequence diagram illustrating an operation at a normal time in the mobility IoT system.

FIG. 19 is a sequence diagram at the time of event detection in the mobility IoT system.

### DETAILED DESCRIPTION

By uploading various data from a vehicle to a cloud, a service provider can provide various services to an end user using the data stored in the cloud. However, as a result of detailed studies by the inventor, in a case where a large amount of data is uploaded from a vehicle to a cloud and a large amount of data is stored in the cloud, an operation cost such as a communication fee and a maintenance cost of a database becomes excessive, and a service usage fee of the end user may increase.

According to one aspect of the present disclosure, in a mobility service system, an amount of data to be communicated and/or stored can be reduced while an appropriate service is provided to an end user.

According to an aspect of the present disclosure, a mobility service system includes an in-vehicle device and a management server. The in-vehicle device is mounted on a vehicle that includes an acquisition device configured to acquire a content including a video or an audio as an acquired content. The management server is configured to collect and store data from in-vehicle devices mounted on vehicles including the vehicle. The in-vehicle device includes an execution unit, an event detection unit, an in-vehicle reduction unit and an upload unit. The execution unit is configured to execute an application program corresponding to a service. The event detection unit is configured to detect an event related to the application program during execution of the application program by the execution unit. The in-vehicle reduction unit is configured to generate an in-vehicle partial content by reducing a data amount of the acquired content using an in-vehicle reduction criterion corresponding to the application program based on the event detection unit detecting the event. The upload unit is configured to upload the in-vehicle partial content generated by the in-vehicle reduction unit to the management server. The management server includes a server reduction unit and a terminal transmission unit. The server reduction unit is configured to generate a server partial content by reducing a data amount of the in-vehicle partial content uploaded by the upload unit using a server reduction criterion corresponding to information related to the in-vehicle device. The terminal transmission unit is configured to transmit a terminal content to a terminal device of an end user of the service based on the server partial content generated by the server reduction unit.

In the aspect of the present disclosure, the in-vehicle device reduces the data amount of the content using the in-vehicle reduction criterion, and the content reduced in data amount is uploaded to the management server. Further, the management server reduces a data amount of the uploaded content using the server reduction criterion and transmits the terminal content to the end user based on the content further reduced in data amount. The in-vehicle reduction criterion depends on the application program, and the server reduction criterion depends on the information related to the in-vehicle device. Therefore, the mobility service system can provide an appropriate service to the end user through the terminal device and reduce a data amount in communication between the in-vehicle device and the management server.

Another aspect of the present disclosure is a method for reducing an amount of data, executed by a mobility service system. The mobility service system includes an in-vehicle device mounted on a vehicle, and a management server configured to collect and store data from in-vehicle devices mounted on vehicles including the vehicle. The vehicle includes an acquisition device configured to acquire a content including a video or an audio as an acquired content. The method includes causing the in-vehicle device to perform (i) executing an application program corresponding to a service, (ii) detecting an event related to the application program during the executing of the application program, (iii) generating an in-vehicle partial content by reducing a data amount of the acquired content using an in-vehicle reduction criterion corresponding to the application program based on the detecting the event, and (iv) uploading the in-vehicle partial content to the management server. The method includes causing the management server to perform (i) generating a server partial content by reducing a data amount of the in-vehicle partial content using a server reduction criterion corresponding to information related to the in-vehicle device, and (ii) transmitting a terminal content to a terminal device of an end user of the service based on the server partial content.

When the mobility service system executes the above method, the same effect as that of the above-described mobility service system can be obtained.

Hereinafter, embodiments of the present disclosure will be described with reference to the drawings.

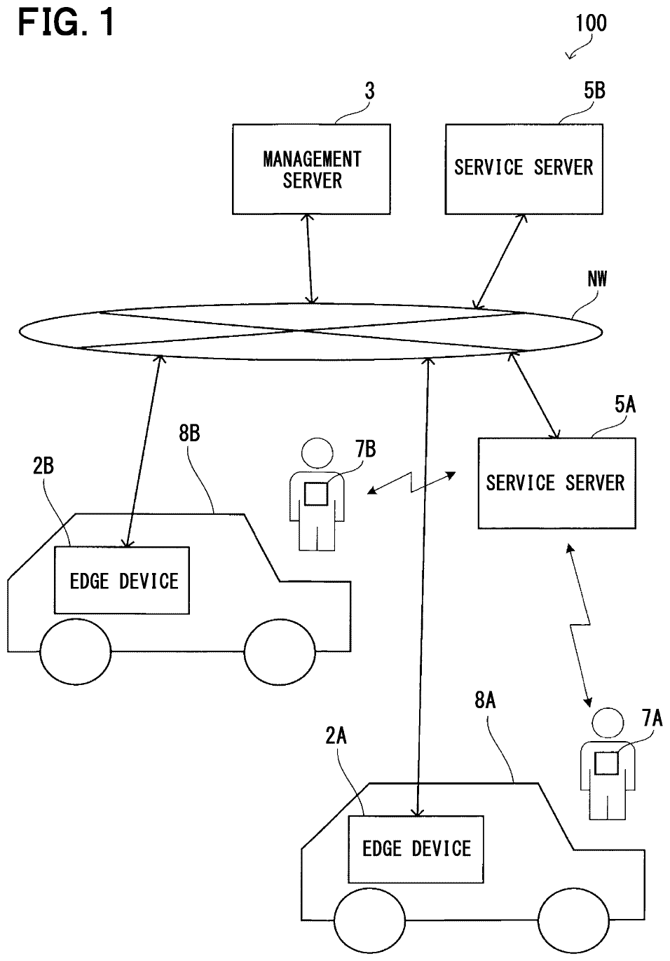

A mobility IoT system 100 illustrated in FIG. 1 includes edge devices 2A and 2B, a management server 3, service servers 5A and 5B, and terminal devices 7A and 7B. IoT stands for Internet of Things. The management server 3 and a service server 5 may be configured as a cloud server. Hereinafter, the edge devices 2A and 2B will be collectively referred to as an edge device 2, and the service servers 5A and 5B will be collectively referred to as a service server 5. The terminal devices 7A and 7B are collectively referred to as a terminal device 7. The mobility IoT system 100 corresponds to a mobility service system of the present disclosure, and the edge devices 2A and 2B correspond to in-vehicle devices of the present disclosure. The management server 3 corresponds to a first management unit of the present disclosure, and the service servers 5A and 5B correspond to a second management unit of the present disclosure.

The edge devices 2A and 2B are mounted on different registered vehicles 8A and 8B. Hereinafter, the registered vehicles 8A and 8B are collectively referred to as a registered vehicle 8. The edge device 2 collects vehicle data of the registered vehicle 8 on which the edge device 2 is mounted, and uploads the collected vehicle data to the management server 3. The edge device 2 executes vehicle control in accordance with an instruction from the management server 3.

The edge device 2 downloads and installs an application program (hereinafter, an application) from the service server 5, and executes the application. Identification information (specifically, the edge device ID) of the edge device 2 is registered in the service server 5 storing the application downloaded by the edge device 2.

The management server 3 communicates with each of the edge devices 2 and each of the service servers 5 via a wide area communication network NW. The management server 3 accumulates the vehicle data uploaded from each of the edge devices 2 in the database. The management server 3 provides each of the service servers 5 with a database of the management server 3 and an interface for accessing the registered vehicle 8.

The service server 5 uses the interface provided by the management server 3 to execute collection of vehicle data corresponding to the registered vehicle 8, vehicle control of the registered vehicle 8, and the like. The service server 5 is owned or managed by a service user. The service user provides various services to end users using various data of the management server 3 via the service server 5. The service user is, for example, a fleet business operator or a car sharing operator. The fleet business operator provides fleet services to end users such as carriers. The car sharing service provides a car sharing service to an end user such as a general driver.

The terminal devices 7 include a smartphone, a tablet terminal, a PC, a smart watch, and the like. Each of the terminal devices 7 is owned by an end user. Each of the terminal devices 7 communicates with a predetermined service server 5 and receives a service from the service server 5. Each of the terminal devices 7 executes an application installed in the edge device 2 and an application corresponding to the installed application. The edge device 2 is associated with the registered vehicle 8 on which the edge device 2 is mounted, the vehicle user of the registered vehicle 8, and the end user who receives the service related to the registered vehicle 8.

The application installed in the edge device 2 is related to the service provided by the service user. The end user subscribes to a service user who provides a desired service, and downloads one or more applications from the service server 5 of the subscribed service user. Two or more applications may correspond to one service.

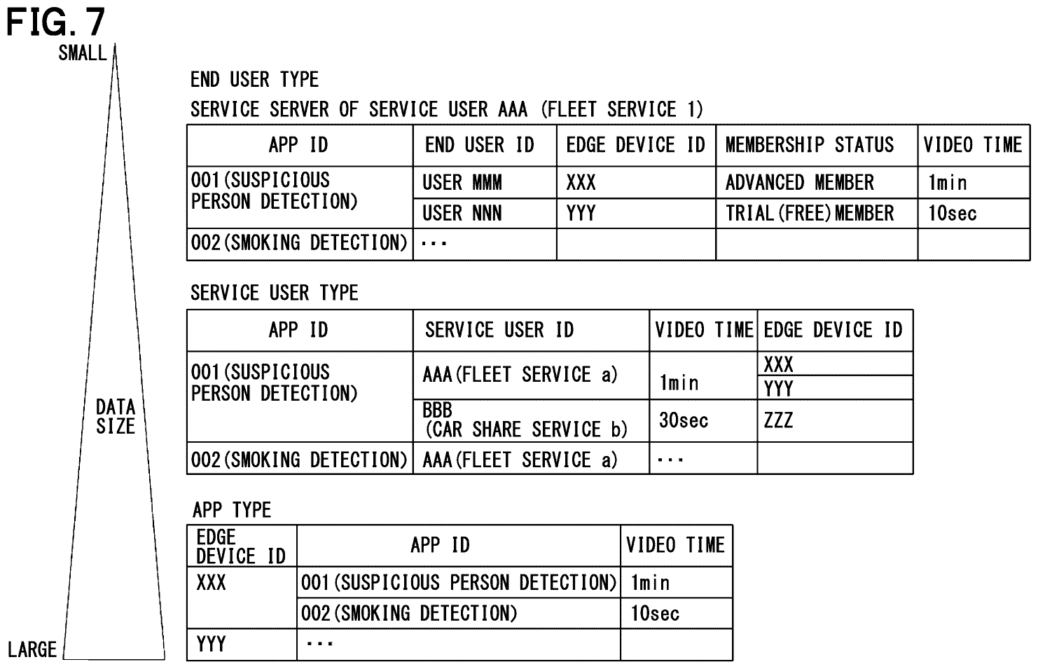

For example, when the end user receives the fleet service from the fleet service provider, the end user downloads a suspicious person detection application A1 and a smoking detection application A2 related to the fleet service from the service server 5 of the fleet service provider (see FIG. 7).

The mobility IoT system 100 may include one or more other edge devices 200 in addition to the edge device 2. Each of the other edge devices 200 collects vehicle data of the vehicle on which it is mounted, and uploads the collected vehicle data to the management server 3. However, each of the other edge devices 200 is not registered in the service server 5 and does not download the application program from the service server 5. That is, the user associated with another edge device 200 does not receive the provision of the service from the service server 5.

In the present embodiment, the service server 5 is provided separately from the management server 3, but may be provided integrally with the management server 3. The mobility IoT system 100 may include three or more service servers 5, or may include three or more edge devices 2.

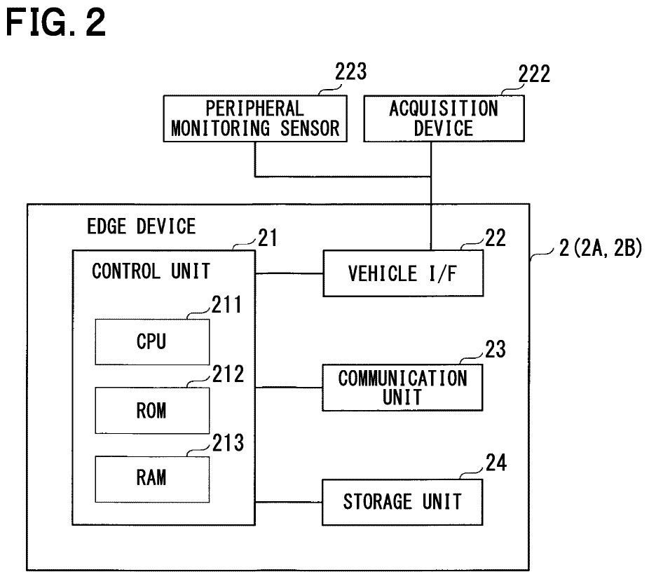

As illustrated in FIG. 2, the edge device 2 includes a control unit 21, a vehicle interface (hereinafter, vehicle I/F) 22, a communication unit 23, and a storage unit 24.

The control unit 21 includes a CPU 211, a ROM 212, and a RAM 213. Various functions of the control unit 21 are implemented by the CPU 211 executing a program stored in a non-transitory tangible recording medium. In the present embodiment, the ROM 212 corresponds to a non-transitory tangible recording medium storing a program. By executing the program, a method corresponding to the program is executed.

The vehicle IF unit 22 is connected to various in-vehicle devices via an in-vehicle network or the like of the registered vehicle 8, and acquires various types of information from the in-vehicle devices. The in-vehicle network may include a controller area network (CAN) and Ethernet. CAN is a registered trademark. Ethernet is a registered trademark. The in-vehicle devices connected to the vehicle IF unit 22 may include a retrofitted exterior device in addition to devices originally mounted on the registered vehicle 8. The in-vehicle device includes one or more acquisition devices 222 and one or more peripheral monitoring sensors 223. The acquisition device 222 is a video camera that captures an image of the vehicle interior and/or a microphone that collects audio, and acquires digital content including video and/or audio. The peripheral monitoring sensor 223 is, for example, a sonar, a rider, a radar, or the like that detects an obstacle existing in a detection range within 3 m around the registered vehicle 8. Further, the in-vehicle device may include a sensor, an acoustic device, a display device, and the like.

The communication unit 23 performs data communication with the management server 3 and the service server 5 via the wide area communication network NW by wireless communication.

The storage unit 24 stores vehicle data and the like acquired via the vehicle IF unit 22. The vehicle data accumulated in the storage unit 24 is uploaded to the management server 3 via the communication unit 23.

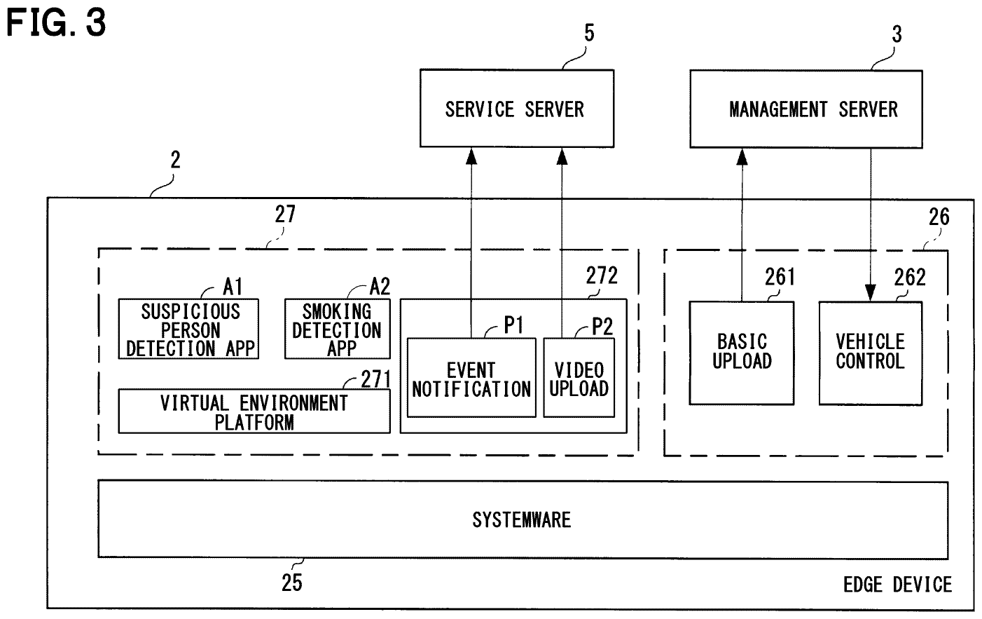

As illustrated in FIG. 3, the edge device 2 includes functions of systemware 25, a core function execution unit 26, and an application execution unit 27. The functions of these units 25 to 27 are implemented by the CPU 211 executing a program stored in the ROM 212.

The systemware 25 includes basic software that abstracts hardware and provides various services necessary for execution of an application program, and drivers for supporting special processing and the like that cannot be standardized. The basic software includes an operating system (hereinafter, OS), a hardware abstraction layer (HAL), and the like. The hardware to be abstracted by the systemware 25 includes an in-vehicle device and an exterior device connected to the edge device 2 via the vehicle IF unit 22 in addition to the hardware included in the edge device 2.

The core function execution unit 26 and the application execution unit 27 are implemented by software operating on the systemware 25.

The core function execution unit 26 has a form of an edge computer that mediates between the management server 3 and the registered vehicle 8. Specifically, the core function execution unit 26 includes a basic upload unit 261 and a vehicle control unit 262. The basic upload unit 261 collects vehicle data of the registered vehicle 8 and uploads the vehicle data to the management server 3. The vehicle control unit 262 controls the registered vehicle 8 in accordance with an instruction from the management server 3.

Here, the vehicle data provided to the management server 3 by the basic upload unit 261 will be described.

The basic upload unit 261 repeatedly collects vehicle data from the registered vehicle 8 via the vehicle IF unit 22. The basic upload unit 261 converts the collected vehicle data into a standard format, and stores the vehicle data in the storage unit 24 in association with the hierarchical classification. Hereinafter, the hierarchized vehicle data is referred to as standardized vehicle data.

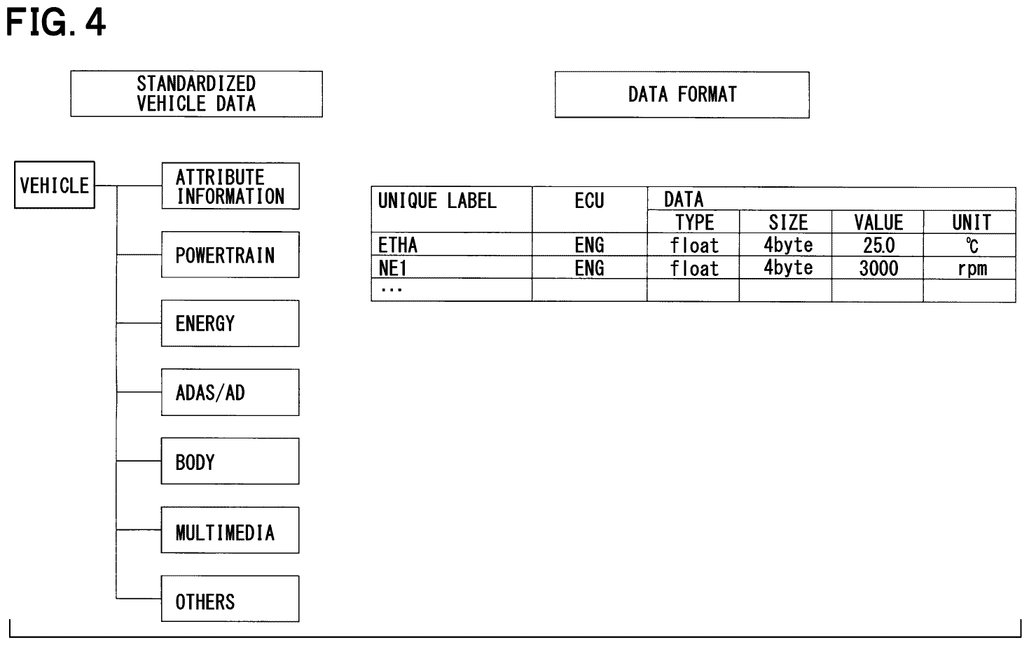

As illustrated in FIG. 4, the standard format of the vehicle data may include “unique label”, “ECU”, “data type”, “data size”, “data value”, and “data unit” as items.

The “unique label” is information for identifying each physical quantity. For example, “ETHA” indicates an intake air temperature, and “NE1” indicates an engine speed.

The “ECU” is information indicating the electronic control unit (hereinafter, ECU) that is the generation source of the vehicle data. For example, “ENG” indicates that the data is generated by the engine ECU.

The “data type” is information for defining the property of the “data value”. The “data type” may include, for example, an integer type, a floating point type, a logical type, a character type, and the like.

The “data size” is information indicating how many bytes the “data value” is expressed.

The “data value” is information indicating a value of a physical quantity specified by the “unique label”.

The “data unit” is information indicating a unit of a data value.

The “data value” is normalized so that the same physical quantity is represented in the same unit regardless of the vehicle type and the vehicle manufacturer.

In addition to identifying “raw data” obtained from the registered vehicle 8, the “unique label” may also include information for identifying “processed data”. The “processed data” corresponds to data converted into a format that can be more easily understood by the user by performing a predetermined operation on one or more “raw data”.

The standardized vehicle data has a plurality of hierarchical structures. For example, as illustrated in FIG. 4, the standardized vehicle data includes “attribute information”, “power train”, “energy”, “ADAS/AD”, “body”, “multimedia”, and “others” as items set in the first layer at the highest level. ADAS stands for Advanced Driver Assistance System. AD stands for Autonomous Driving. Each item belonging to the first layer represents a category of the vehicle data.

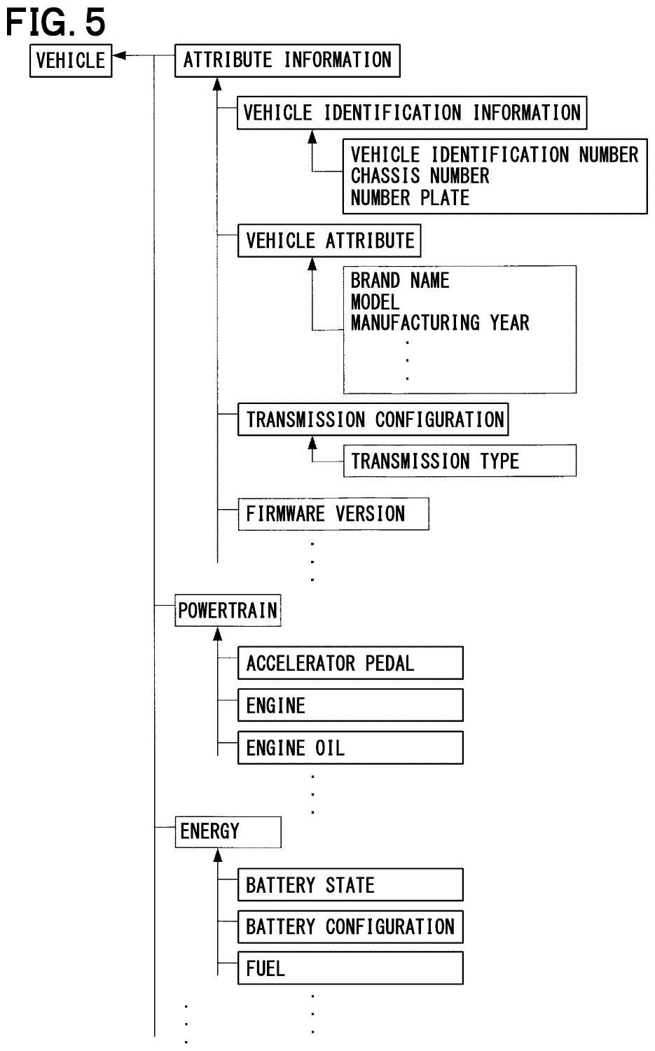

As illustrated in FIG. 5, the standardized vehicle data may include a second layer and a third layer in addition to the first layer. The second layer is a layer immediately below the first layer, and the third layer is a layer immediately below the second layer.

For example, the “attribute information” which is an item on the first layer includes “vehicle identification information”, “vehicle attribute”, “transmission configuration”, “firmware version”, and the like as items on the second layer. The “power train” which is an item on the first layer includes “accelerator pedal”, “engine”, “engine oil”, and the like as items on the second layer. The “energy” which is an item on the first layer includes “battery state”, “battery configuration”, “fuel”, and the like as items on the second layer. Each item belonging to the second layer also represents a category of the vehicle data.

For example, the “vehicle identification information”, which is an item on the second layer, includes “vehicle identification number”, “chassis number”, and “number plate” as items on the third layer. The “vehicle attribute”, which is an item on the second layer, includes “brand name”, “model”, “year of manufacture”, and the like as items on the third layer. The “transmission configuration”, which is an item in the second layer, includes “transmission type” as an item in the third layer. Although not illustrated, the “accelerator pedal”, which is an item on the second layer, includes “accelerator pedal state”, “accelerator pedal opening degree”, and the like as items on the third layer. The item “engine” in the second layer includes “engine state”, “rotation speed”, and the like as items in the third layer. Each item in the third layer corresponds to the “unique label” of the standard format. That is, the individual vehicle data is stored in association with each item on the third layer. The individual vehicle data belonging to the standardized vehicle data is also referred to as an item.

As described above, each item on the first layer includes one or more items on the second layer, and each item on the second layer includes one or more items on the third layer, that is, vehicle data.

For example, the vehicle data in which the “unique label” is the “vehicle identification information” is stored in a storage area in which the first layer is the “attribute information”, the second layer is the “vehicle identification information”, and the third layer is the “vehicle identification number” in the standardized vehicle data.

The item “others” on the first layer may include, for example, position information acquired from a GPS device mounted on the registered vehicle 8 via the vehicle IF unit 22, that is, latitude, longitude, and altitude.

Next, a procedure in which the basic upload unit 261 uploads the vehicle data to the management server 3 will be described.

A transmission cycle for transmitting data to the management server 3 is set in each piece of vehicle data belonging to the standardized vehicle data. The transmission cycle is set to be shorter for data that changes frequently and/or to be shorter for data with higher importance according to the degree of change of data, the importance of data, and/or the like. That is, each vehicle data is transmitted at a frequency corresponding to the characteristic. The transmission cycle is, for example, a 500 ms cycle, a 2 s cycle, a 4 s cycle, a 30 s cycle, a 300 s cycle, a 12 hour cycle, or the like.

The transmission timing is set to, for example, a cycle of 250 ms. Each vehicle data is uploaded at a determined transmission timing according to the schedule. The schedule is set so that transmission of a large amount of vehicle data is not concentrated at the same transmission timing.

Returning to FIG. 3, the application execution unit 27 will be described. The application execution unit 27 provides a function of executing application programs (hereinafter, an external application) A1, A2, . . . which are optionally installed later. The application execution unit 27 includes a virtual environment platform 271 and a library 272.

The virtual environment platform 271 has a function of simplifying execution and management of the containerized external application Ai by virtualizing the OS included in the systemware 25. The external application Ai is executed on the virtual environment platform 271. The external application Ai includes the suspicious person detection application A1 and the smoking detection application A2.

The library 272 is a program group for providing a fixed function commonly used by the external application Ai. The library 272 includes an event notification program P1 and a video upload program P2. The event notification program P1 provides a function of transmitting an event notification to the service server 5 in accordance with an instruction from the external application Ai. The video upload program P2 provides a function of uploading the video acquired by the acquisition device 222 to the service server 5 according to an instruction from the external application Ai.

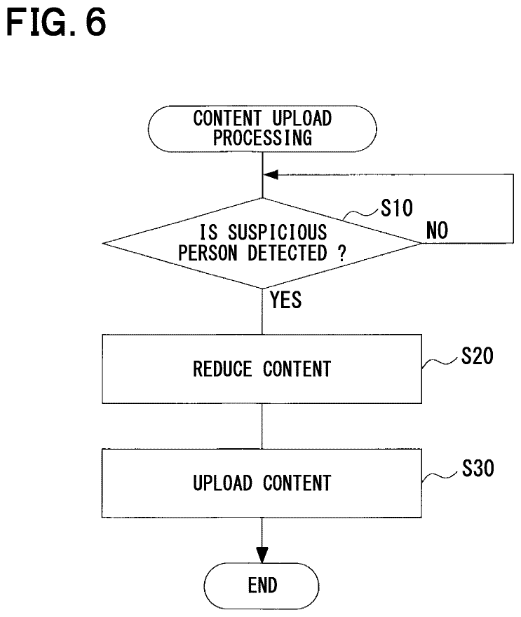

Content data upload processing executed by the CPU 211 of the edge device 2 will be described with reference to a flowchart of FIG. 6. In the present embodiment, the content data upload processing during execution of the suspicious person detection application A1 by the CPU 211 will be described.

The CPU 211 may execute the content data upload processing while the external application Ai other than the suspicious person detection application A1 is being executed. Examples of the other external application Ai include the smoking detection application A2. The CPU 211 may execute the above-described upload processing when detecting smoking by executing the smoking detection application A2.

In S10, the CPU 211 determines whether a suspicious person has been detected. When the execution of the suspicious person detection application A1 is started, the CPU 211 determines whether the registered vehicle 8 is in a parked state, and activates the peripheral monitoring sensor 223 via the vehicle IF unit 22 when the registered vehicle 8 is in a parked state. When a moving object is detected by the peripheral monitoring sensor 223, the CPU 211 activates the acquisition device 222 via the vehicle IF unit 22 to start acquisition of content. The CPU 211 determines whether a suspicious person is detected on the basis of the video included in the content acquired by the acquisition device 222. The CPU 211 and a function achieved by the control step S10 may correspond to an event deletion unit configured to detect an event related to an application program during execution of the application program by the execution unit.

Specifically, the CPU 211 detects a suspicious person when (i) the moving object is determined to be a person on the basis of the video, and (ii) the moving object determined to be a person is continuously present within the detection range of the peripheral monitoring sensor 223 for a certain period of time or more. Here, the suspicious person is other than the vehicle user registered in advance as the user of the registered vehicle 8 on which the edge device 2 is mounted.

In S10, when it is determined that the suspicious person is not detected, the CPU 211 repeatedly executes the processing of S10, and when it is determined that the suspicious person is detected, the CPU proceeds to the processing of S20.

In S20, the CPU 211 reduces the data amount of the content acquired by the acquisition device 222 on the basis of an in-vehicle reduction criterion. In the present embodiment, the acquired content is a video. The in-vehicle reduction criterion corresponds to a reduction rate, a reduction amount, or a data amount after reduction of the data amount of the content. That is, the CPU 211 reduces the data amount of the content from the start of the acquisition device 222 to the present time. The CPU 211 and a function achieved by the control step S20 may correspond to an in-vehicle reduction unit configured to generate an in-vehicle partial content by reducing a data amount of the acquired content using the in-vehicle reduction criterion corresponding to the application program based on the event detection unit detecting the event.

In the present embodiment, the reduction is to reduce the information amount of the content itself, in other words, to irreversibly reduce the information amount of the content. That is, in the present embodiment, the reduction does not include compression of the information amount of the content that can return the information amount to the original amount. Specifically, in the present embodiment, the reduction corresponds to cutting out a part of content information or thinning out content information. Cutting out a part of the information of the content includes cutting out (or extracting) a part of the image, and cutting the beginning and the end of the video to extract an intermediate portion. Decimating the information includes reducing resolution/image quality and decimating frames of the video (for example, one frame is extracted for every five frames) into continuous still images.

In the present embodiment, the reduction criterion indicates a reduction amount (that is, the amount to be decreased) of the information of the content and/or a method of cutting out or thinning out the information amount. For example, the reduction criterion indicates a reduction amount of the information of the content such as ** bytes, *** minutes, and **** frame number. The reduction criterion indicates a reduction method such as cutting for the first one minute and the last one minute, or reducing the full high vision (HD) image quality to the standard (SD) image quality, for example.

In the present embodiment, increasing the reduction criterion corresponds to increasing the reduction amount of the information of the content, and eventually corresponds to increasing the reduction rate or the reduction amount of the content. Reducing the reduction criterion corresponds to reducing the reduction amount of the information of the content, and eventually corresponds to reducing the reduction rate or the reduction amount of the content.

When the content is a video, the data amount of the content depends on the time, the number of frames, and the image quality (or resolution) of the video. When the content is a video, the CPU 211 reduces the data amount of the video by (i) shortening the video time, (ii) reducing the image quality of the video, or (iii) decimating the frames of the video, on the basis of the in-vehicle reduction criterion. The in-vehicle reduction criterion corresponds to the external application Ai being executed by the CPU 211. When the edge device 2 downloads the external application Ai from the service server 5, the in-vehicle reduction criterion is downloaded to the edge device 2 together with the external application Ai and the application ID of the external application Ai. The application ID and the in-vehicle reduction criterion are stored in the storage unit 24 of the edge device 2.

Depending on service content provided by the service user, a data amount of content necessary for implementing the service varies. The service provided by the service user corresponds to an application executed by the CPU 211. Therefore, the CPU 211 changes the reduction rate, the reduction amount, or the data amount after the reduction of the data amount of the content related to the application according to the application being executed.

For example, as illustrated in FIG. 7, during the execution of the suspicious person detection application A1, the CPU 211 reduces the data amount of the content (specifically, the video) to generate an in-vehicle partial content for 1 minute. This one minute period is centered on the time point at which the suspicious person is detected. During the execution of the smoking detection application A2, the CPU 211 reduces the data amount of the content and generates the in-vehicle partial content for 10 seconds. This 10 second period is centered on the time point at which smoking is detected.

Subsequently, in S30, the CPU 211 uploads the in-vehicle partial content generated in S20 to the management server 3 in association with the application ID and the edge device ID, and ends this process. The CPU 211 and a function achieved by the control step S30 may correspond to an upload unit configured to upload the in-vehicle partial content generated by the in-vehicle reduction unit to the management server.

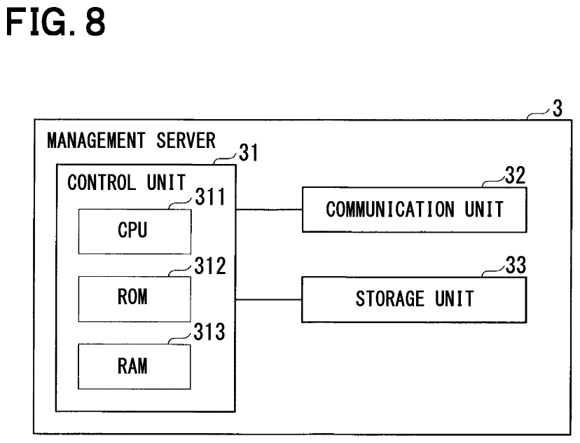

As illustrated in FIG. 8, the management server 3 includes a control unit 31, a communication unit 32, and a storage unit 33. The management server 3 corresponds to the first management unit of the present disclosure.

The control unit 31 includes a CPU 311, a ROM 312, and a RAM 313. Various functions of the control unit 31 are implemented by the CPU 311 executing a program stored in a non-transitory tangible recording medium. In this example, the ROM 312 corresponds to a non-transitory tangible recording medium storing a program. By executing the program, a method corresponding to the program is executed.

The communication unit 32 performs data communication with the plurality of edge devices 2 and the service server 5 via the wide area communication network NW. For communication with the edge device 2, for example, message queue telemetry transport (MQTT), which is a simple and lightweight protocol of a publishing/subscribing type, may be used.

The storage unit 33 is a database that stores vehicle data, content data, and the like provided from the edge device 2.

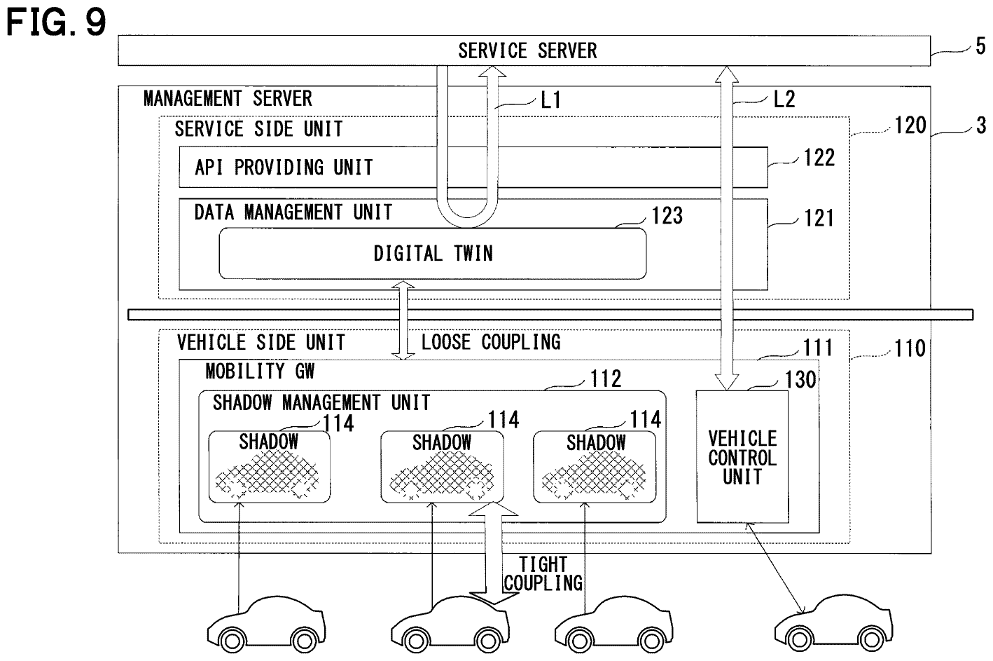

As illustrated in FIG. 9, the management server 3 has functions of a vehicle side unit 110 and a service side unit 120.

A method for implementing these functions of the management server 3 is not limited to software, and some or all of the elements may be implemented using one or a plurality of pieces of hardware. For example, in a case where the above-described function is implemented by an electronic circuit which is hardware, the electronic circuit may be implemented by a digital circuit including a large number of logic circuits, an analog circuit, or a combination thereof.

The vehicle side unit 110 includes a mobility gateway (hereinafter, the mobility GW) 111.

The mobility GW 111 includes a shadow management unit 112 and a vehicle control unit 130. The shadow management unit 112 has a function of managing a shadow 114 provided for each vehicle on which the edge device 2 is mounted. The shadow 114 is generated on the basis of the standardized vehicle data transmitted from the edge device 2. The vehicle control unit 130 has a function of controlling the registered vehicle 8 on which the edge device 2 is mounted in accordance with an instruction from the service server 5.

The service side unit 120 includes a data management unit 121 and an API providing unit 122. API stands for Application Programming Interface.

The data management unit 121 has a function of managing a digital twin 123, which is a virtual space for providing vehicle access independent of a change in the connection state of the vehicle. The digital twin 123 is one of databases constructed on the storage unit 33.

The API providing unit 122 is an interface for the service server 5 to access the mobility GW 111 and the data management unit 121.

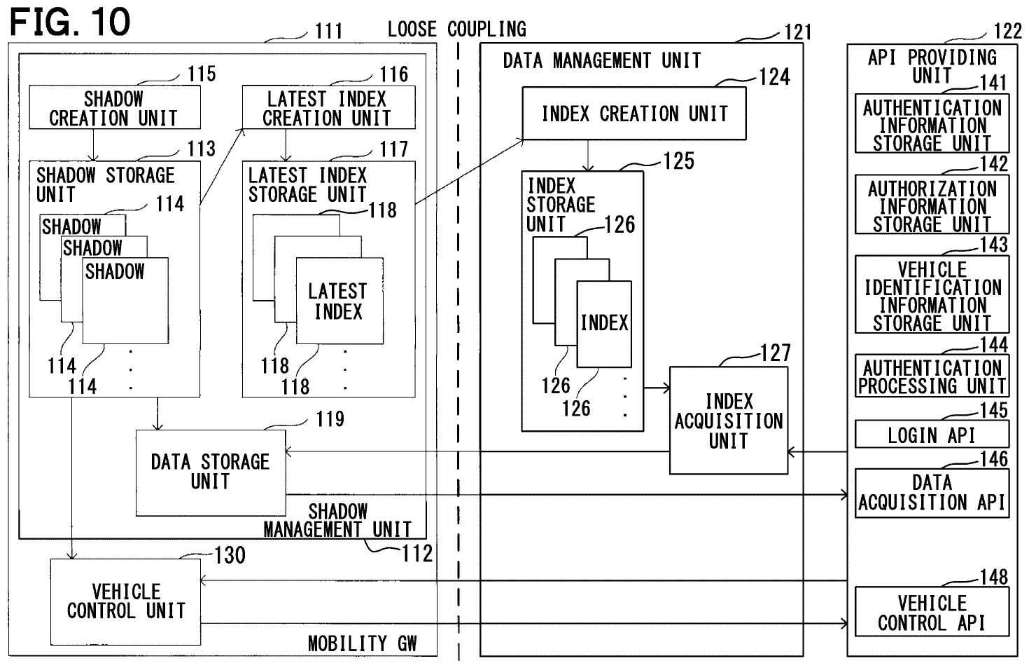

As illustrated in FIG. 10, the shadow management unit 112 includes a shadow creation unit 115, a shadow storage unit 113, a latest index creation unit 116, and a latest index storage unit 117 as a configuration for implementing a function of accumulating vehicle data acquired from the edge device 2.

Every time the vehicle data is transmitted from the edge device 2, the shadow creation unit 115 updates the standardized vehicle data by overwriting the transmitted vehicle data over the corresponding area of the structured standardized vehicle data. That is, the standardized vehicle data is provided for each vehicle and is updated asynchronously.

The shadow creation unit 115 simultaneously creates a new shadow 114 for all the vehicles at a constant cycle using the updated standardized vehicle data. The shadow creation unit 115 accumulates the created shadow 114 in the shadow storage unit 113. Thus, the shadow storage unit 113 stores a plurality of shadows 114 created in time series for each vehicle. That is, the shadow 114 can be regarded as a copy of a state at a certain time of the vehicle on which the edge device 2,200 is mounted.

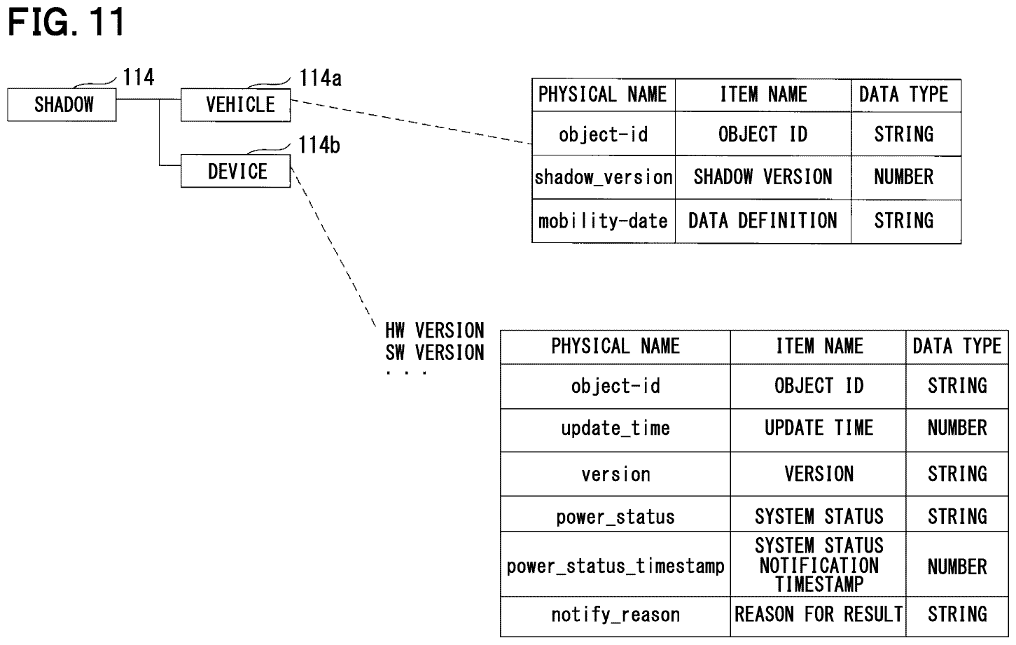

As illustrated in FIG. 11, a shadow 114 includes a vehicle data storage unit 114a and a device data storage unit 114b.

The vehicle data storage unit 114a stores “object-id”, “Shadow_version”, and “mobility-data” as data related to the vehicle (hereinafter, mounted vehicle) on which the edge device 2,200 is mounted.

The “object-id” is a character string for identifying the mounted vehicle, and functions as a partition key.

The “Shadow_version” is a numerical value indicating a version of shadow 114, and a time stamp indicating a creation time is set every time shadow 114 is created.

The “mobility-data” is a value of the standardized vehicle data at the time indicated by the time tap.

The device data storage unit 114b stores “object-id”, “update_time”, “version”, “power_status”, “power_status_timestamp”, and “notify_reason” as data regarding hardware, software, and a state mounted on the edge device 2.

The “object-id” is a character string for identifying the mounted vehicle, and functions as a partition key.

The “update_time” is a numerical value indicating an update time of hardware and software.

The “version” is a character string indicating versions of hardware and software.

The “power_status” is a character string indicating the system status of the edge device 2. Specifically, there are a “power on” state in which all functions are available, and a “power off” state in which some functions are stopped and low power consumption is achieved.

The “power_status_timestamp” is a numerical value indicating the notification time of the system status.

The “notify_reason” is a character string indicating a notification reason.

When a change occurs in the “version”, “power_status”, “notify_reason”, and the like stored in the device data storage unit 114b, a notification is given from the edge device 2 separately from the standardized vehicle data.

Returning to FIG. 10, the latest index creation unit 116 will be described. The latest index creation unit 116 acquires the latest shadow 114 for each vehicle from the shadow storage unit 113, and creates the latest index 118 using the acquired shadow 114. The latest index creation unit 116 stores the created latest index 118 in the latest index storage unit 117. The latest index storage unit 117 stores one latest index 118 for each vehicle (that is, for each object-id).

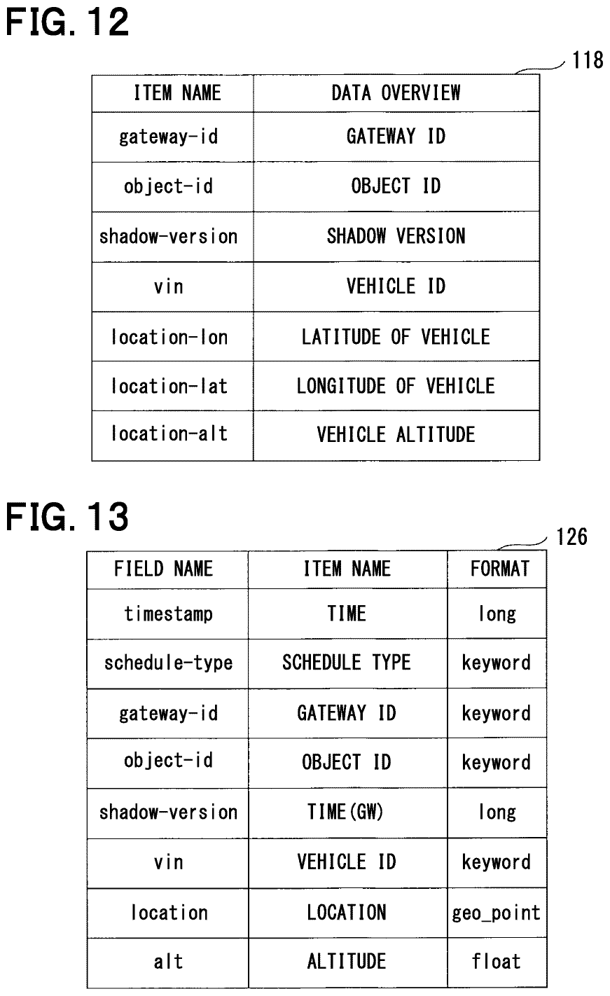

As illustrated in FIG. 12, the latest index 118 stores “gateway-id”, “object-id”, “shadow-version”, “vin”, “location-lon”, “location-lat”, and “location-alt”.

The “object-id” and the “shadow-version” are similar to those described in the shadow 114.

The “gateway-id” is information for identifying the mobility GW 111. For example, in a case where a plurality of management servers 3 is provided for each country, the management server 3 is information for identifying the management servers 3.

The “vin” is a unique registration number assigned to the mounted vehicle.

The “location-lon” is information indicating the latitude at which the mounted vehicle is present.

The “location-lat” is information indicating the longitude at which the mounted vehicle is present.

The “location-alt” is information indicating the altitude at which the mounted vehicle is present.

Returning to FIG. 10, the data management unit 121 will be described. The data management unit 121 includes an index creation unit 124 and an index storage unit 125. The index creation unit 124 and the index storage unit 125 correspond to a configuration that implements a function of accumulating the latest index 118 acquired from the shadow management unit 112 as an index 126.

The index creation unit 124 acquires the latest index 118 from the latest index storage unit 117 according to a preset acquisition schedule, and creates the index 126 for the digital twin 123 using the acquired latest index 118. The index creation unit 124 sequentially stores the created index 126 in the index storage unit 125. Thus, the index storage unit 125 stores a plurality of indexes 126 created in time series for each vehicle. That is, each of the indexes 126 stored in the index storage unit 125 represents a vehicle existing on the digital twin 123 which is a virtual time space.

As illustrated in FIG. 13, the index 126 stores “timestamp”, “schedule-type”, “gateway-id”, “object-id”, “shadow-version”, “vin”, “location”, and “alt”.

The “timestamp” is a timestamp indicating the time at which the index 126 is created in units of milliseconds.

The “schedule-type” indicates whether the scheduler of the data creation source is a periodic scheduler or an event. In a case where the event is a periodic event, the “schedule-type” is set to “Repeat”, and in a case where the event is an event, the “schedule-type” is set to “Event”.

The “gateway-id”, the “object-id”, the “shadow-version”, and the “vin” are information taken over from the latest index 118.

The “location” is information taken over from “location-lon” and “location-lat” of the latest index 118, and “alt” is information taken over from “location-alt” of the latest index 118.

As illustrated in FIGS. 9 and 10, the service side unit 120 includes an API providing unit 122. The API providing unit 122 is an interface prepared for allowing an external service user to use the function and/or data of the management server 3 via the service server 5 or the like.

As illustrated in FIG. 10, the API providing unit 122 includes an authentication information storage unit 141, an authorization information storage unit 142, a vehicle identification information storage unit 143, and an authentication processing unit 144. A login API 145, a data acquisition API 146, and a vehicle control API 148 are provided as types of APIs provided to the service user.

The authentication information storage unit 141 stores “authentication information” in association with “service user ID”. The “service user ID” is identification information for uniquely identifying the service user. The “authentication information” is a preset password.

The authorization information storage unit 142 stores “authorization information” in association with “service user ID”. The “authorization information” is information in which a range of available services among all services provided by the management server 3 is designated for each service user.

The vehicle identification information storage unit 143 stores table information in which “object-id” uniquely assigned to the mounted vehicle is associated with the “vin” of the edge-equipped vehicle.

The authentication processing unit 144 executes authentication processing when an authentication request is made via the login API 145, and executes authorization processing when an access request is made via the data acquisition API 146 and the vehicle control API 148.

The login API 145 is used when logging in to the management server 3. When the login API 145 receives an authentication request from a service user, the authentication processing unit 144 executes authentication processing. In the authentication processing, the “service user ID” and the “authentication information” input by the login API 145 are collated with the registered content of the authentication information storage unit 141. As a result of the collation, when the information is matched, that is, when the authentication is successful, the access to the management server 3 is permitted.

The data acquisition API 146 is an API used for accessing the vehicle data (that is, the index 126 and the shadow 114) accumulated in the management server 3 as indicated by L1 in FIG. 9. The vehicle control API 148 is an API used for accessing the edge-equipped vehicle as indicated by L2 in FIG. 9.

The data acquisition API 146 and the vehicle control API 148 may perform the authorization processing when receiving an access request from a service user. The authorization processing is processing of permitting or denying an access request according to an authority previously given to the service user.

In the data acquisition API 146 and the vehicle control API 148, either “object-id” or “vin” may be used as the information for specifying the vehicle. When the “vin” is used as the information for specifying the vehicle, the vehicle identification information storage unit 143 may be referred to, and the information for specifying the vehicle may be converted from “vin” to “object-id”.

As illustrated in FIG. 10, the management server 3 includes an index acquisition unit 127 and a data acquisition unit 119 as a configuration for processing an access request (hereinafter, data acquisition request) via the data acquisition API 146.

Data acquisition processing executed by the index acquisition unit 127 and the data acquisition unit 119 when the data acquisition API 146 receives a data acquisition request from a service user will be described.

The data acquisition request includes vehicle designation information, time designation information, and data designation information.

The vehicle designation information is information for designating a vehicle (hereinafter, target vehicle) serving as a provider of vehicle data. The vehicle designation information includes a method of listing vehicle IDs (that is, object-id or vin) of target vehicles in a list form and a method of designating (hereinafter, area designation) a geographical area where the target vehicles are present.

The time designation information is information for designating a timing at which data is generated. The time designation information is represented by a starting time and a range. The range is, for example, a value in which a time width is represented by an integer of 1 or more with a generation cycle of the latest index 118 as a unit time.

The data designation information is information for designating data to be acquired. The data designation information may represent the item name of the data indicated in the standardized vehicle data in a list form, or may be represented by designating a category name indicated in the standardized vehicle data. The designation of the category name corresponds to designation of all items belonging to the category. The fact that neither the item name nor the category name is designated corresponds to the fact that all the items are designated.

The way of setting the vehicle designation information, the time designation information, and the data designation information described here is an example, and the method is not limited to the above method.

The index acquisition unit 127 extracts all the indexes 126 having “timestamp” within the time range indicated by the time designation information for all the vehicles specified from the vehicle designation information indicated in the data acquisition request.

The index acquisition unit 127 generates shadow specifying information obtained by combining “object-id” and “shadow-version” indicated by the index 126 for each of the extracted indexes 126. Thus, a shadow list in which the shadow specifying information is listed is generated.

The index acquisition unit 127 outputs a shadow access request in which the data designation information indicated in the data acquisition request is added to the generated shadow list to the data acquisition unit 119 of the shadow management unit 112.

That is, the index acquisition unit 127 uses the vehicle designation information and the time designation information indicated in the data acquisition request from the data acquisition API 146 as acquisition conditions, and generates the shadow list according to the acquisition conditions. The index acquisition unit 127 outputs a shadow access request in which the generated shadow list and the data designation information are combined to the data acquisition unit 119.

When the shadow access request from the index acquisition unit 127 is input, the data acquisition unit 119 refers to the shadow storage unit 113 and extracts the shadow 114 corresponding to each shadow specifying information indicated in the shadow list of the shadow access request. Further, the data acquisition unit 119 extracts designation data, which is data indicated in the data designation information of the shadow access request, from each of the extracted shadows 114, and returns the extracted designation data as an access result to the data acquisition API 146 as a request source.

As illustrated in FIG. 10, the management server 3 includes a vehicle control unit 130 as a configuration for processing an access request (vehicle control request) via the vehicle control API 148.

A vehicle control process executed by the vehicle control unit 130 when the vehicle control API 148 receives a vehicle control request from a service user will be described.

The vehicle control request includes vehicle designation information, execution target information, and control designation information. The vehicle control request may further include priority information, time limit information, and vehicle authentication information.

The vehicle designation information includes one vehicle ID. The vehicle specified from the vehicle ID is a target vehicle to be controlled.

The execution target information designates an application mounted on the registered vehicle 8 to execute the control content indicated in the control designation information. The execution target information includes an application ID for identifying an application.

The control designation information includes details of specific control to be executed by the registered vehicle 8. For example, the control designation information may include key operations of various doors such as a door of each seat and a trunk door, operations of acoustic equipment such as a horn and a buzzer, operations of various lamps such as a head lamp and a hazard lamp, and operations of various sensors such as the acquisition device 222 and a radar. The control designation information may include one control or may include a plurality of controls to be continuously executed in the form of a list. The plurality of controls in the form of a list is executed in the order of the list.

The priority information indicates a priority when a control instruction generated based on the vehicle control request is transmitted toward the registered vehicle 8. The priority information may be set by a service user as a request source, or may be automatically set according to the content of control indicated in the control designation information.

The time limit information indicates the last time at which control by the registered vehicle 8 is permitted. The time limit information is set up to, for example, +10 minutes from the time when the vehicle control request is input. Similarly to the priority information, the time limit information may be set by a service user as a request source, or may be automatically set according to the content of control requested to the vehicle.

The vehicle authentication information is information used to determine whether the target vehicle may accept the control instruction, and may include an owner ID and a password for identifying the owner of the target vehicle. The vehicle authentication information is held in the registered vehicle 8, and is also held by a service user who is permitted to access the vehicle.

When a vehicle control request is input from the vehicle control API 148, the vehicle control unit 130 transmits one or a plurality of control instructions generated on the basis of the vehicle control request to the target vehicle.

When receiving the control instruction from the management server 3, the edge device 2 collates the vehicle authentication information indicated in the control instruction with the vehicle authentication information of the own vehicle to perform authentication.

When the edge device 2 succeeds in the authentication, the edge device 2 causes the application specified from the implementation designation information to execute the control included in the control designation information. The edge device 2 transmits a response including the execution result of the control to the management server 3.

Upon receiving the response, the vehicle control unit 130 returns the response content to the vehicle control API 148.

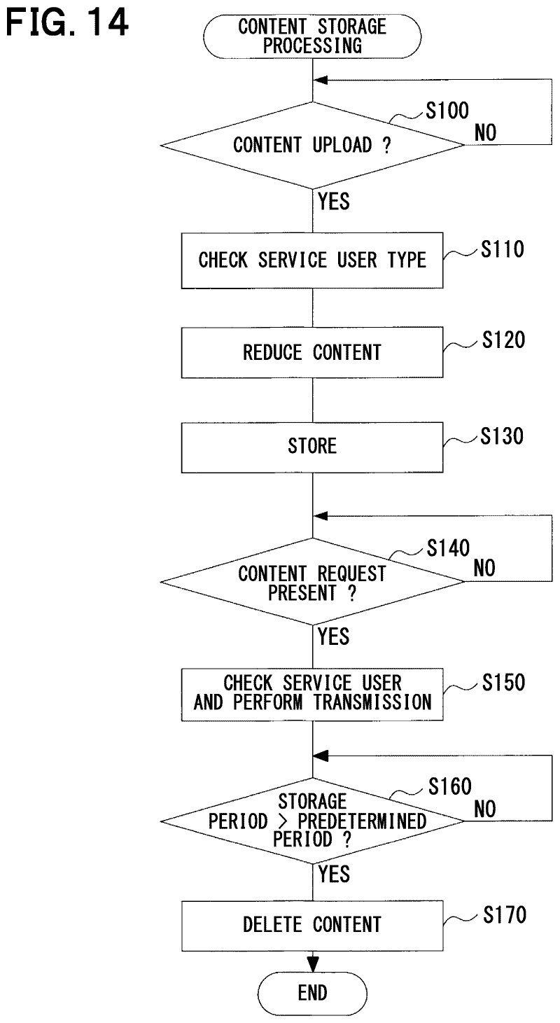

Content storage processing executed by the CPU 311 of the management server 3 will be described with reference to a flowchart of FIG. 14. The CPU 311 repeatedly executes the content storage processing at a predetermined cycle.

In S100, the CPU 311 determines whether the in-vehicle partial content has been uploaded from the edge device 2 to the management server 3. That is, the CPU 311 determines whether the in-vehicle partial content is received from the edge device 2. When determining that the in-vehicle partial content has been uploaded, the CPU 311 proceeds to the processing of S110, and when determining that the in-vehicle partial content has not been uploaded, the CPU repeatedly executes the processing of S100.

In S110, the CPU 311 checks the service user type corresponding to the uploaded in-vehicle partial content, specifically, the service user ID. The service user type corresponds to one group divided by grouping related to a plurality of in-vehicle devices, and a plurality of end users to which one service provider provides a service via the service server 5 belong to one group.

Each of the service users provides a predetermined service to one or more end users associated with the plurality of edge devices 2. The end user receives a predetermined service when each of the one or more edge devices 2 executes one or more applications.

For example, as illustrated in FIG. 7, a service user AAA provides a fleet service a and bundles a first edge device group, a first vehicle group, or a first vehicle user group associated with the fleet service a. The service user BBB provides the car sharing service b and bundles the second edge device group, the second vehicle group, or the second vehicle user group related to the car sharing service b. The first edge device group corresponds to a plurality of edge devices 2 having a plurality of edge device IDs including “XXX” and “YYY”. The first vehicle group corresponds to the plurality of registered vehicles 8 on which the first edge device group is mounted. The first vehicle user group corresponds to one or more vehicle users of the first vehicle group. The second edge device group corresponds to a plurality of edge devices 2 having a plurality of edge device IDs including “ZZZ”. The second vehicle group corresponds to the plurality of registered vehicles 8 on which the second edge device group is mounted. The second vehicle user group corresponds to one or more vehicle users of the second vehicle group.

Further, the group corresponding to one service user may be divided into a plurality of sub-groups according to a predetermined feature. The predetermined feature is, for example, a vehicle type, and a group corresponding to one service user may be divided into a group of light vehicles, a group of ordinary vehicles, and a group of trucks. That is, the service user may divide one group that provides the same type of service into a plurality of sub-groups, and provide a difference in the content of the service for each sub-group. For example, the service user AAA may change the content of the fleet service provided to the group of ordinary vehicles to the content of the fleet service provided to the group of trucks.

As illustrated in FIG. 7, the management server 3 stores the application ID, the service user ID, a first management reduction criterion, and the edge device ID in the storage unit 33 in association with each other. The management server 3 refers to the storage unit 33 to acquire the service user ID corresponding to the edge device ID associated with the in-vehicle partial content.

In step S120, the CPU 311 reduces the in-vehicle partial content uploaded to the management server 3 on the basis of the first management reduction criterion, and generates a first management partial content. The first management reduction criterion corresponds to a reduction rate, a reduction amount, or a data amount after reduction of the data amount of the in-vehicle partial content. The first management reduction criterion is different according to identification information of edge devices 2, identification information of registered vehicles 8, or identification information of a group that bundles vehicle users, such as a service user ID. For example, the management server 3 sets the first management reduction criterion according to the contract content for each service user, and stores the first management reduction criterion in the storage unit 33 in association with the service user ID. The CPU 311 uses the first management reduction criterion corresponding to the service user type checked in S110. The CPU 311 and a function achieved by the operation of the control step S120 may correspond to a server reduction unit configured to generate a server partial content by reducing a data amount of the in-vehicle partial content uploaded by the upload unit using a server reduction criterion corresponding to information related to the in-vehicle device. The first management partial content is an example of the server partial content, and the first management reduction criterion is an example of the server reduction criterion. More specifically, The CPU 311 and a function achieved by the operation of the control step S120 may correspond to a first management reduction unit included in the server reduction unit and configured to generate the first management partial content by reducing the data amount of the in-vehicle partial content uploaded by the upload unit using the first management reduction criterion.

The CPU 311 reduces the data amount of the in-vehicle partial content by (i) shortening the video time of the in-vehicle partial content, (ii) reducing the image quality of the in-vehicle partial content, or (iii) decimating the frames of the in-vehicle partial content, on the basis of the first management reduction criterion corresponding to the service user ID checked in S110.

A data amount of necessary content varies depending on service content provided by the service user. Therefore, the contract regarding the amount of data stored in the management server 3 is different for each service user. For example, as illustrated in FIG. 7, the service user AAA has a contract with the management server 3 to store content for one minute for the suspicious person detection application A1. Therefore, the management server 3 reduces a first in-vehicle partial content and generates the first management partial content for one minute. The first in-vehicle partial content is content uploaded from the edge device 2 having an edge device ID of “XXX” or “YYY”. The service user BBB reduces a second in-vehicle partial content and generates the first management partial content of 30 seconds. The second in-vehicle partial content is content uploaded from the edge device 2 having the edge device ID of “ZZZ”.

When the group corresponding to one service user includes a plurality of sub-groups, the first management reduction criterion is set for each sub-group. Therefore, the CPU 311 changes the reduction amount of the data amount for each sub-group. The CPU 311 generates the first management partial content by reducing the in-vehicle partial content on the basis of the corresponding first management reduction criterion for each sub-group.

The data amount of the first management partial content is not necessarily smaller than the data amount of the in-vehicle partial content, and may be the same as the data amount of the in-vehicle partial content. For example, when both the in-vehicle reduction criterion and the first management reduction criterion are a video time of one minute, the first management partial content is not reduced from the in-vehicle partial content and becomes the same content as the in-vehicle partial content.

Subsequently, in S130, the CPU 311 stores the first management partial content generated in S120 in the storage unit 33 in association with the application ID, the edge device ID, and the service user ID.

Subsequently, in S140, the CPU 311 determines whether there is a content request from any of the service servers 5. When determining that there is a content request, the CPU 311 proceeds to the processing of S150, and when determining that there is no content request, the CPU repeatedly executes the processing of S140.

In S150, the CPU 311 checks the service user who has requested the content. That is, the CPU 311 checks the service user ID associated with the service server 5 (that is, the service user) that has requested the content. The CPU 311 transmits the first management partial content used by the service user to the service server 5 of the checked service user The CPU 311 and a function achieved by the control step S150 may correspond to a first transmission unit configured to transmit the first management partial content to the second management unit in response to a request received from the second management unit while the first management partial content transmitted corresponds to the request among the first management partial contents stored in the storage unit.

Subsequently, in S160, the CPU 311 determines whether the storage period of each of the stored first management partial contents exceeds a predetermined period. When the storage period of all the first management partial contents is the predetermined period or less, the CPU 311 repeatedly executes the process of S160. When the storage period of any of the first management partial contents exceeds the predetermined period, the CPU 311 proceeds to the processing of S170.

In S170, the CPU 311 deletes the first management partial content whose storage period exceeds the predetermined period from the storage unit 33, and ends the processing. In S160, instead of determining whether the storage period exceeds the predetermined period, the CPU 311 may determine whether the number of times of transmission of each piece of the stored first management partial content exceeds the set number of times. The number of times of transmission is the number of times of transmission of the first management partial content from the management server 3 to the service server 5. In S170, the CPU 311 may delete the first management partial content whose number of times of transmission exceeds the set number of times from the storage unit 33.

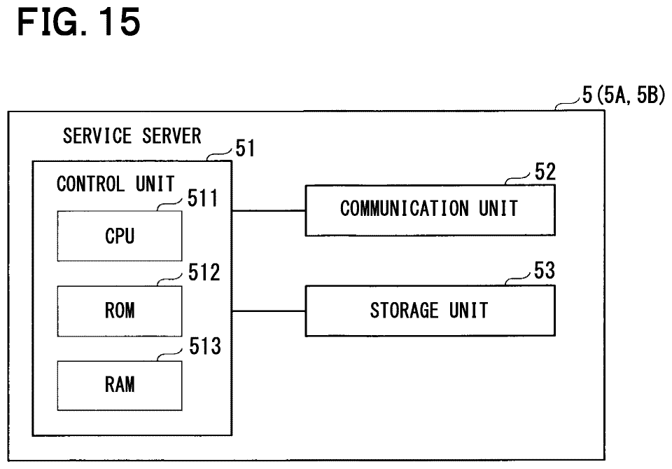

As illustrated in FIG. 15, the service server 5 includes a control unit 51, a communication unit 52, and a storage unit 53. The service server 5 corresponds to a second management unit of the present disclosure.

The control unit 51 includes a CPU 511, a ROM 512, and a RAM 513. Various functions of the control unit 51 are implemented by the CPU 511 executing a program stored in a non-transitory tangible recording medium. In this example, the ROM 512 corresponds to a non-transitory tangible recording medium storing a program. By executing the program, a method corresponding to the program is executed.

The communication unit 52 communicates with the edge device 2, the management server 3, and the terminal device 7 via the wide area communication network NW. For communication with the terminal device 7, a network different from the network used for communication with the management server 3 may be used.

The storage unit 53 stores various types of information necessary for providing the service.

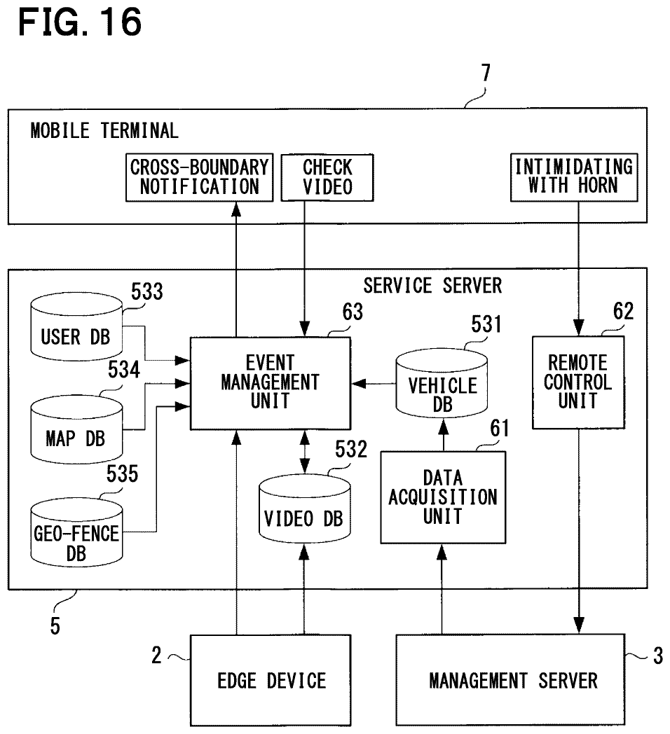

As illustrated in FIG. 16, the service server 5 includes a data collecting unit 61, a remote control unit 62, and an event management unit 63. The service server 5 includes a plurality of databases (hereinafter, DB), specifically, a vehicle DB 531, a video DB 532, a user DB 533, a map DB 534, and a geo-fence DB 535.

The vehicle DB 531 stores vehicle data acquired by the data collecting unit 61 from the management server 3. The video DB 532 stores video data uploaded from the edge device 2. The user DB 533 stores driver information that is information on the driver of the registered vehicle 8. The driver information includes a vehicle ID of the registered vehicle 8 associated with the driver and a method of contacting the terminal device 7 (for example, a telephone number, a mail address, or the like). The map DB 534 stores map information used for navigation and the like. The geo-fence DB 535 stores a geo-fence set on the basis of the position of the registered vehicle 8 stored in the vehicle DB 531 and the map information stored in the map DB 534. The geo-fence is an area surrounded by a virtual geographical boundary line.

The data collecting unit 61 repeatedly acquires the position information of all the registered vehicles 8 using the data acquisition API provided by the management server 3, and stores the latest position information of each registered vehicle 8 in the vehicle DB 531.

The remote control unit 62 executes vehicle control of the designated registered vehicle 8 using the vehicle control API 148 provided by the management server 3 in accordance with an instruction from the terminal device 7.

Upon receiving the event notification from the edge device 2, the event management unit 63 executes processing according to the content of the event notification.

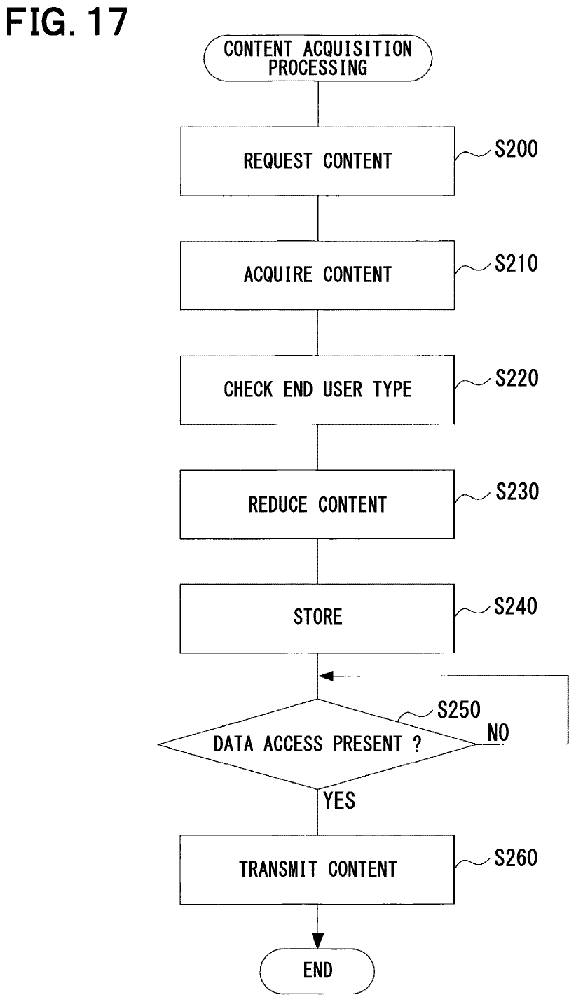

Content acquisition processing executed by the CPU 511 of the service server 5 will be described with reference to a flowchart of FIG. 17. The CPU 511 repeatedly executes the content acquisition processing at a predetermined cycle.

In S200, the CPU 511 requests the management server 3 to which the service user has a contract for content corresponding to the contract content.

In S210, the CPU 511 acquires the first management partial content transmitted from the management server 3. The CPU 511 and a function achieved by the control step S210 may correspond to reception unit configured to receive the first management partial content transmitted by the first transmission unit.

In S220, the CPU 511 checks the end user type corresponding to the first management partial content acquired in S210, specifically, the end user ID. For example, as illustrated in FIG. 7, the service server 5 of the service user AAA stores the application ID, the end user ID, the edge device ID, a member status, and the second management criterion in the storage unit 53 in association with each other. The CPU 511 acquires the end user ID corresponding to the edge device ID associated with the first management partial content. The end user type corresponds to identification information of an end user who uses the service of the present disclosure or an in-vehicle device or a vehicle user.

Subsequently, in S230, the CPU 511 reduces the received first management partial content on the basis of a second management criterion, and generates a second management partial content. The second management criterion corresponds to a reduction rate, a reduction amount, or a reduced data amount of the first management partial content. The second management criterion changes according to the end user ID or the like. That is, the second management criterion changes according to the identification information of the end user, the edge device 2, the registered vehicle 8, or the vehicle user corresponding to the service provided by the service server 5. The CPU 511 and a function achieved by the operation of the control step S230 may correspond to the server reduction unit. The second management partial content is an example of the server partial content, and the second management reduction criterion is an example of the server reduction criterion. More specifically, The CPU 511 and a function achieved by the operation of the control step S230 may correspond to a second management reduction unit included in the server reduction unit and configured to generate the second management partial content by reducing a data amount of the first management partial content received by the reception unit using the second management criterion.

The service user assigns a membership status to each of the end users, and associates the end user ID with the member status. The service user changes the content of the service to be provided according to the member status. For example, the service user provides a richer service to an end user having a relatively high member status than an end user having a relatively low membership status. Therefore, the service reduction criterion changes according to the member status, and the CPU 511 reduces the reduction amount of the data amount as the member status corresponding to the end user ID becomes higher.

The CPU 511 reduces the data amount of the first management partial content by (i) reducing the video time of the first management partial content, (ii) reducing the image quality of the first management partial content, or (iii) decimating the frames of the first management partial content, on the basis of the second management criterion corresponding to the end user ID checked in S220.

For example, as illustrated in FIG. 7, the CPU 511 reduces the data amount of the first management partial content and generates the second management partial content for 1 minute in order to provide a service to the end user MMM of the senior member. That is, the CPU 511 generates the second management partial content for 1 minute from the first management partial content based on the content uploaded from the edge device 2 having the edge device ID of “XXX”. The edge device ID of “XXX” is associated with the end user MMM.

In order to provide a service to the end user NNN of the trial member, the CPU 511 reduces the data amount of the first management partial content and generates the second management partial content for 10 seconds. That is, the CPU 511 generates the second management partial content for 10 seconds from the first management partial content based on the content uploaded from the edge device 2 having the edge device ID of “YYY”.

The data amount of the second management partial content does not necessarily need to be smaller than the data amount of the first management partial content, and may be the same as the data amount of the first management partial content. When both the second management criterion and the first management reduction criterion are a video time of one minute, the second management partial content is not reduced from the first management partial content and becomes the same content as the first management partial content.

Subsequently, in S240, the CPU 511 stores the second management partial content generated in S230 in the storage unit 53.

Subsequently, in S250, the CPU 511 determines whether there is an access to data from the terminal device 7 of the end user. When determining that there is an access, the CPU 511 proceeds to the processing of S260, and when determining that there is no access, the CPU repeatedly executes the processing of S250.

In S260, the CPU 511 identifies the end user who has made the data access on the basis of the end user ID assigned to the access. The CPU 511 transmits a terminal content to the corresponding terminal device 7 on the basis of the second management partial content corresponding to the end user who has accessed the data. The terminal content may be the same as the second management partial content, or may be content obtained by processing the second management partial content. In the present embodiment, the second management partial content corresponds to the service partial content of the present disclosure. The CPU 511 and a function achieved by the control step S260 may correspond to a terminal transmission unit configured to transmit a terminal content to a terminal device of an end user of the service based on the server partial content generated by the server reduction unit.

A terminal application is installed in the terminal device 7. The terminal application includes a graphic user interface (hereinafter, GUI), and has functions of displaying a notification from the service server 5, reproducing a video of the vehicle interior, and instructing the service server 5 to perform vehicle control.

A video viewing screen, a menu button, and the like are displayed on the GUI of the terminal application. The menu button includes a video reproduction button and a vehicle control button.

Upon receiving a suspicious person detection notification, a smoking detection notification, or the like, the terminal application may perform notification by voice or vibration using an acoustic device or the like mounted on the terminal device 7 in addition to displaying an icon or the like indicating that the detection notification has been received on the display screen of the terminal device 7.

When the terminal device 7 receives a video-up notification from the service server 5, the terminal application enables the video reproduction button. When the enabled video reproduction button is operated, the terminal application reproduces the video of the vehicle interior on the video viewing screen.

The terminal application enables the vehicle control button when the video of the vehicle interior is reproduced. When the enabled vehicle control button is operated, the terminal application instructs the service server 5 to perform vehicle control. When there is a plurality of executable vehicle controls, a vehicle control button may be prepared for each type of vehicle control.

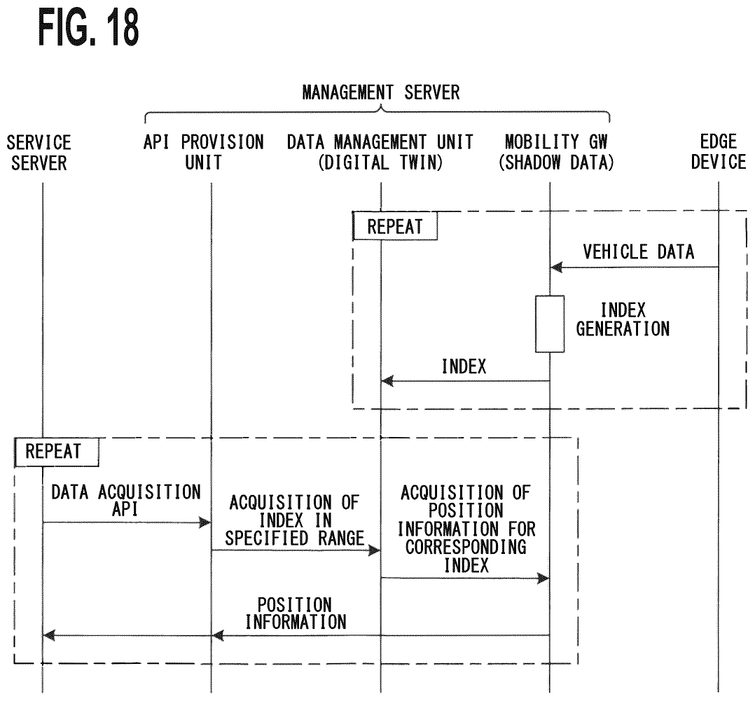

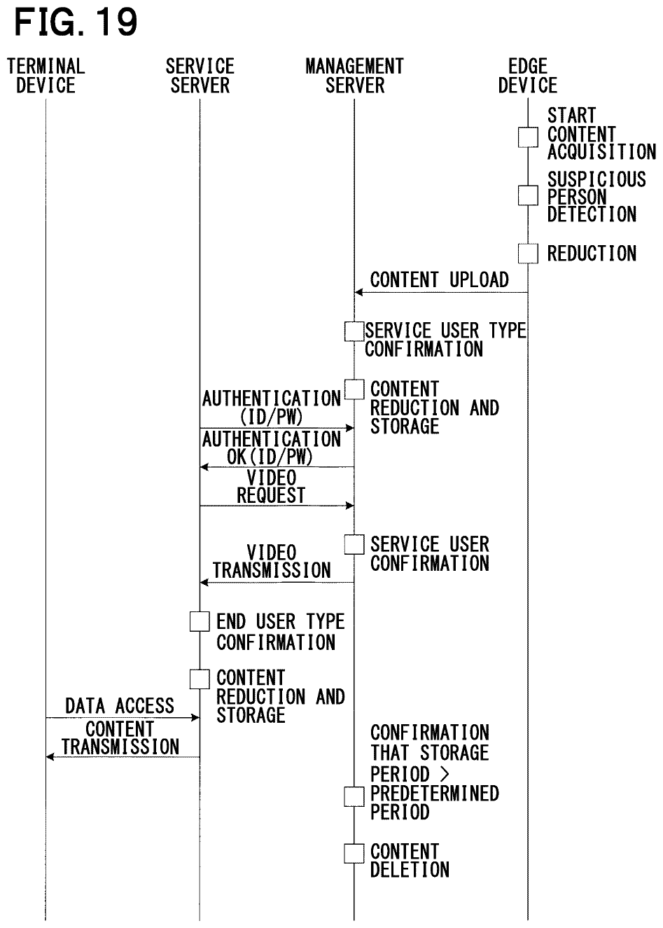

The operation of the entire mobility IoT system 100 will be described with reference to the sequence diagrams of FIGS. 18 and 19.

As illustrated in FIG. 17, at the normal time, the edge device 2 repeatedly transmits the vehicle data of the registered vehicle 8 on which the edge device 2 is mounted to the management server 3 according to the schedule.

The mobility GW 111 of the management server 3 accumulates the received vehicle data as the shadow 114 and generates the latest index 118. The data management unit 121 of the management server 3 accumulates the latest index 118 as the digital twin 123. The digital twin 123 includes at least identification information and position information of all edge-equipped vehicles.

That is, in the management server 3 on the cloud, the vehicle data of all the vehicles on which the edge device 2 is mounted is sequentially updated and accumulated as the shadow 114 and the digital twin 123.

The data collecting unit 61 of the service server 5 repeatedly acquires the position information of the registered vehicle 8 during execution of the suspicious person detection application A1 using the data acquisition API 146 provided by the management server 3, and stores the latest position information in the vehicle DB 531.

In the data acquisition request input to the data acquisition API 146, for example, a service provision range is set as position designation information, the current time is set as the time designation information, and the position information is set as the acquisition information. The data management unit 121 generates an object list designating object IDs and current times of all the registered vehicles 8 existing within the service designation range. The mobility GW 111 extracts the latest position information from the shadow 114 according to the object list and returns the position information to the service server 5.

As illustrated in FIG. 19, when the execution of the suspicious person detection application A1 is started, the edge device 2 starts content acquisition by the acquisition device 222. When the edge device 2 detects the suspicious person on the basis of the content acquired by the acquisition device 222, the edge device 2 reduces the data amount of the content by the in-vehicle reduction criterion, and generates the in-vehicle partial content. The edge device 2 uploads the generated in-vehicle partial content to the management server 3.

The management server 3 checks the type of the service user corresponding to the uploaded in-vehicle partial content. The management server 3 reduces the data amount of the in-vehicle partial content on the basis of the first management reduction criterion corresponding to the checked type of the service user, generates the first management partial content, and stores the first management partial content in the storage unit 33.

The service server 5 requests the management server 3 for authentication in order to use the content of the management server 3. The management server 3 executes authentication processing of the service server 5, and when the authentication is successful, transmits authentication OK to the service server 5. When the authentication OK is received, the service server 5 requests a content from the management server 3. The management server 3 checks the service user corresponding to the service server 5. The management server 3 transmits the first management partial content corresponding to the checked service user to the service server 5.

The service server 5 checks the type of the end user corresponding to the received first management partial content. The service server 5 reduces the data amount of the first management partial content on the basis of the second management criterion according to the checked type of the end user, generates the second management partial content, and stores the second management partial content in the storage unit 53.

The terminal device 7 accesses data of the service server 5 in order to receive a service from the service server 5. The service server 5 transmits the terminal content based on the second management partial content corresponding to the end user of the terminal device 7 to the terminal device 7.

According to the present embodiment described in detail above, the following effects are obtained.

(1) The edge device 2 reduces the data amount of the content on the basis of the in-vehicle reduction criterion, so that the communication amount between the edge device 2 and the management server 3 can be reduced. The management server 3 reduces and saves the data amount of the in-vehicle partial content uploaded on the basis of the first management reduction criterion, so that it is possible to reduce the data amount saved by the management server 3 and to reduce the communication amount between the management server 3 and the service server 5. The service server 5 reduces and saves the data amount of the received first management partial content using the second management criterion, so that the data amount saved by the service server 5 can be reduced.

(2) As the status of the end user becomes higher, the service server 5 increases the data amount of the second management partial content used for the service to the end user. Thus, the service user can provide a higher quality service to an end user with a high status.

(3) The management server 3 can change the degree of reduction of the first management partial content for each service user who provides the first management partial content. That is, the management server 3 can change the degree of reduction of the first management partial content for each service provided to the end user. Therefore, the end user can receive an appropriate service from the service user.

(4) By dividing a group of end users who receive the same type of service into sub-groups, the management server 3 can change the degree of reduction of the first management partial content for each sub-group. In addition, the service user can provide more appropriate services to the end user.

(5) When the content includes the video, the data amount of the content can be reduced by either one of shortening of the video time, reducing the image quality, and decimating the frames.

(6) The management server 3 can reduce the amount of data stored in the storage unit 33 by deleting the first management partial content whose storage period exceeds the set period from the database.

(7) The management server 3 can reduce the amount of data stored in the storage unit 33 by deleting, from the database, the first management partial content whose number of times of transmission to the service server 5 exceeds the set number of times.

Although the embodiments of the present disclosure have been described above, the present disclosure is not limited to the above-described embodiments, and various modifications can be made.

(a) In the above embodiment, the management server 3 reduces the data amount of the in-vehicle partial content, but the management server 3 need not reduce the data amount of the in-vehicle partial content. That is, the management server 3 may store the in-vehicle partial content as the first management partial content and transmit the same to the service server 5.

(b) In the above embodiment, the service server 5 reduces the data amount of the first management partial content, but the service server 5 need not reduce the data amount of the first management partial content. That is, the service server 5 may store the first management partial content as the second management partial content and transmit the first management partial content to the terminal device 7.

(c) In the above embodiment, the CPU 311 of the management server 3 deletes the first management partial content whose storage period exceeds the set period or the first management partial content whose number of times of transmission exceeds the set number of times from the storage unit 33, but the CPU 511 of the service server 5 may similarly delete the second management partial content from the storage unit 53. That is, CPU 511 may delete the second management partial content whose storage period exceeds the set period or the second management partial content whose number of times of transmission exceeds the set number of times from storage unit 53.

(d) The control units 21, 31, and 51 and the method thereof described in the present disclosure may be implemented by a dedicated computer provided by configuring a processor and a memory programmed to execute one or a plurality of functions embodied by a computer program. Alternatively, the control units 21, 31, and 51 and the method thereof described in the present disclosure may be implemented by a dedicated computer provided by configuring a processor by one or more dedicated hardware logic circuits. Alternatively, the control units 21, 31, and 51 and the method thereof described in the present disclosure may be implemented by one or more dedicated computers configured by a combination of a processor and a memory programmed to execute one or a plurality of functions and a processor configured by one or more hardware logic circuits. The computer program may be stored in a computer-readable non-transition tangible recording medium as an instruction executed by a computer. The method for implementing the functions of the units included in the control units 21, 31, and 51 does not necessarily include software, and all the functions may be implemented using one or a plurality of pieces of hardware.

(e) A plurality of functions of one component in the above embodiment may be implemented by a plurality of components, or one function of one component may be implemented by a plurality of components. A plurality of functions of a plurality of components may be implemented by one component, or one function implemented by a plurality of components may be implemented by one component. A part of the configuration of the above embodiment may be omitted. At least a part of the configuration of the above embodiment may be added to or replaced with the configuration of another above embodiment.

(f) In addition to the mobility system described above, the present disclosure can be implemented in various forms such as various programs for causing each of the in-vehicle device, the management server, and the service server included in the mobility system to function, and a non-transitory tangible recording medium such as a semiconductor memory in which these programs are recorded.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A mobility service system comprising:
an in-vehicle device mounted on a vehicle including an acquisition device configured to acquire a content including a video or an audio as an acquired content; and
a management server configured to collect and store data from in-vehicle devices mounted on vehicles including the vehicle, wherein
the in-vehicle device includes
an execution unit configured to execute an application program corresponding to a service,
an event detection unit configured to detect an event related to the application program during execution of the application program by the execution unit,
an in-vehicle reduction unit configured to generate an in-vehicle partial content by reducing a data amount of the acquired content using an in-vehicle reduction criterion corresponding to the application program based on the event detection unit detecting the event, and
an upload unit configured to upload the in-vehicle partial content generated by the in-vehicle reduction unit to the management server, and
the management server includes
a server reduction unit configured to generate a server partial content by reducing a data amount of the in-vehicle partial content uploaded by the upload unit using a server reduction criterion corresponding to information related to the in-vehicle device, and
a terminal transmission unit configured to transmit a terminal content to a terminal device of an end user of the service based on the server partial content generated by the server reduction unit.

2. The mobility service system according to claim 1, wherein
the management server includes a first management unit and a second management unit,
the server reduction criterion includes a first management reduction criterion determined based on grouping of the in-vehicle devices,
the first management unit includes
a first management reduction unit included in the server reduction unit and configured to generate a first management partial content by reducing the data amount of the in-vehicle partial content uploaded by the upload unit using the first management reduction criterion,
a storage unit configured to store first management partial contents generated by the first management reduction unit, and
a first transmission unit configured to transmit a first management partial content to the second management unit in response to a request received from the second management unit, the first management partial content transmitted corresponding to the request among the first management partial contents stored in the storage unit,
the second management unit includes
a reception unit configured to receive the first management partial content transmitted by the first transmission unit, and
the terminal transmission unit, and
the terminal transmission unit is configured to transmit the terminal content to the terminal device based on the first management partial content.

3. The mobility service system according to claim 1, wherein
the management server includes a first management unit and a second management unit,
the server reduction criterion includes a second management criterion determined based on identification information related to the in-vehicle device,
the first management unit includes
a storage unit configured to store first management partial contents based on in-vehicle partial contents uploaded by the upload unit, and
a first transmission unit configured to transmit a first management partial content to the second management unit in response to a request received from the second management unit, the first management partial content transmitted corresponding to the request among the first management partial contents stored in the storage unit,
the second management unit includes
a reception unit configured to receive the first management partial content transmitted by the first transmission unit,
a second management reduction unit included in the server reduction unit and configured to generate a second management partial content by reducing a data amount of the first management partial content received by the reception unit using the second management criterion, and
the terminal transmission unit, and
the terminal transmission unit is configured to transmit the terminal content to the terminal device based on the second management partial content.

4. The mobility service system according to claim 2, wherein
the server reduction criterion includes a second management criterion determined based on identification information related to the in-vehicle device,
the second management unit further includes
a second management reduction unit included in the server reduction unit and configured to generate a second management partial content by reducing a data amount of the first management partial content received by the reception unit using the second management criterion, and
the terminal transmission unit is configured to transmit terminal content to the terminal device based on the second management partial content.

5. The mobility service system according to claim 3, wherein
the server reduction criterion includes a first management reduction criterion determined based on grouping of the in-vehicle devices, and
the first management unit includes
a first management reduction unit included in the server reduction unit and configured to generate a first management partial content by reducing of a data amount of the in-vehicle partial content uploaded by the upload unit using the first management reduction criterion.

6. The mobility service system according to claim 4, wherein
the second management reduction unit is configured to reduce the data amount of the first management partial content such that a reduction amount of the data amount is smaller in a case where the identification information corresponds to a high status than a case where the identification information corresponds to a low status, and
the identification information is identification information of the end user, identification information of a user of the in-vehicle device or identification information of the vehicle.

7. The mobility service system according to claim 4, wherein
the grouping forms one group to which end users of the service provided by one service provider via the second management unit belong.

8. The mobility service system according to claim 4, wherein
the grouping forms one group including sub-groups, and
the first management reduction unit is configured to reduce the data amount of the in-vehicle partial content such that a reduction amount of the data amount is different for each of the sub-groups.

9. The mobility service system according to claim 1, wherein
the acquired content includes a video, and
the reducing of the data amounts by the in-vehicle reduction unit and the server reduction unit corresponds to one of shortening of video time, reducing image quality, or decimating frames.

10. The mobility service system according to claim 2, wherein
the first management unit further includes
a deletion unit configured to delete the first management partial content from the storage unit based on elapse of a set period from the first management partial content being stored in the storage unit.

11. The mobility service system according to claim 2, wherein
the first management unit includes
a deletion unit configured to delete the first management partial content from the storage unit based on a number of times the first transmission unit transmits the first management partial content to the second management unit exceeding a set number of times.

12. A method for reducing an amount of data, executed by a mobility service system, the mobility service system including an in-vehicle device mounted on a vehicle, and a management server configured to collect and store data from in-vehicle devices mounted on vehicles including the vehicle, the vehicle including an acquisition device configured to acquire a content including a video or an audio as an acquired content, the method comprising:
causing the in-vehicle device to perform
executing an application program corresponding to a service,
detecting an event related to the application program during the executing of the application program,
generating an in-vehicle partial content by reducing a data amount of the acquired content using an in-vehicle reduction criterion corresponding to the application program based on the detecting the event, and
uploading the in-vehicle partial content to the management server; and
causing the management server to perform
generating a server partial content by reducing a data amount of the in-vehicle partial content using a server reduction criterion corresponding to information related to the in-vehicle device, and
transmitting a terminal content to a terminal device of an end user of the service based on the server partial content.
